(19) United States
(12) Patent Application Publication
(10) Pub. No.: US 2008/0241370 A1
(43) Pub. Date: Oct. 2, 2008

(54) COATING REMOVAL FROM VANE RINGS VIA TUMBLE STRIP

(75) Inventor: Robert Topa, Wichita Falls, TX (US)

Correspondence Address: BACHMAN & LAPOINTE, P.C., 900 CHAPEL STREET, SUITE 1201, NEW HAVEN, CT, 06510, US

(73) Assignee: PRATT & WHITNEY CANADA CORP., Longueuil (CA)

(21) Appl. No.: 11/692,315

(22) Filed: Mar. 28, 2007

(51) Int. Cl. B05C 9/00

(52) U.S. Cl. 427/142

(57) ABSTRACT

A method of removing a coating layer from a gas turbine component, including a step of applying both mechanical and chemical actions in a tumble stripping process to the coating layer of the gas turbine component, wherein the gas turbine component is bathed in an acid solution while being rubbed by a plurality of hard media elements in a tumbling motion.

### TECHNICAL FIELD

The invention relates generally to a method of removing a coating layer from a gas turbine component, and more particularly to an improved method of removing a coating layer from a gas turbine airfoil component

### BACKGROUND OF THE ART

Gas turbine components, particularly gas turbine airfoil components such as turbine rotor blades and vane rings, are usually coated with a coating layer used as a thermal barrier to protect the components from high temperatures. However, such thermal barrier coating must be removed when the gas turbine component is to be repaired. The removal of the coating layer, particularly from turbine blades and vane rings is difficult because the coating layer is very thin and takes on the characteristics and composition of the base metal of the component, especially in the diffusion zones of the coating layer. An electrolytic striping process using dilute acids has been in practice for decades and is especially effective where the electromotive force potential between the base metal of the component and the metal to be stripped (the coating layer) is great. Graphite is often chosen as a counter-electrode because it is not attacked by acids and is therefore not consumed in the stripping process. Usually the work piece is made anodic and the container wall or a counter-electrode is made cathodic. Electrical current flow from a power supply aids in the stripping reaction and metal (the coating layer) is quickly removed from the substrate (the component). Nevertheless, the weakness of electrolytic stripping processes is that sharp edges of parts are more aggressively etched and pitting can quickly result if conditions of the acid bath change subtly.

Accordingly, there is a need to provide an improved stripping process for removal of a coating layer of a gas turbine component.

### SUMMARY OF THE INVENTION

It is therefore an object of this invention to provide an improved stripping process for removal of the coating layer of a gas turbine component.

In one aspect, the present invention provides a method of removing a coating layer from a gas turbine airfoil component, comprising a step of applying both mechanical and chemical actions in a tumble stripping process to the coating layer of the gas turbine airfoil component, wherein the gas turbine airfoil component is bathed in an acid solution while being rubbed by a plurality of hard media elements in a tumbling motion.

In another aspect, the present invention provides a method of removing a coating layer from a gas turbine component, the coating layer including at least one metal element different from a base metal of the component, the method comprising a step of applying both mechanical and chemical actions in a tumble stripping process to the coating layer of the component, wherein the gas turbine component is bathed in an acid solution while being rubbed by a plurality of hard media elements in a tumbling motion.

Further details of these and other aspects of the present invention will be apparent from the detailed description and figures included below.

### DESCRIPTION OF THE DRAWINGS

Reference is now made to the accompanying drawings depicting aspects of the present invention, in which:

FIG. 1 is a schematic illustration of a tumbling stripping process according to one embodiment of the present invention; and

FIG. 2 is a schematic illustration of a method for applying protective materials into an internal cavity of a gas turbine airfoil component, prior to the tumbling stripping process in accordance with another embodiment of the present invention.

### DETAILED DESCRIPTION OF THE PREFERRED EMBODIMENTS

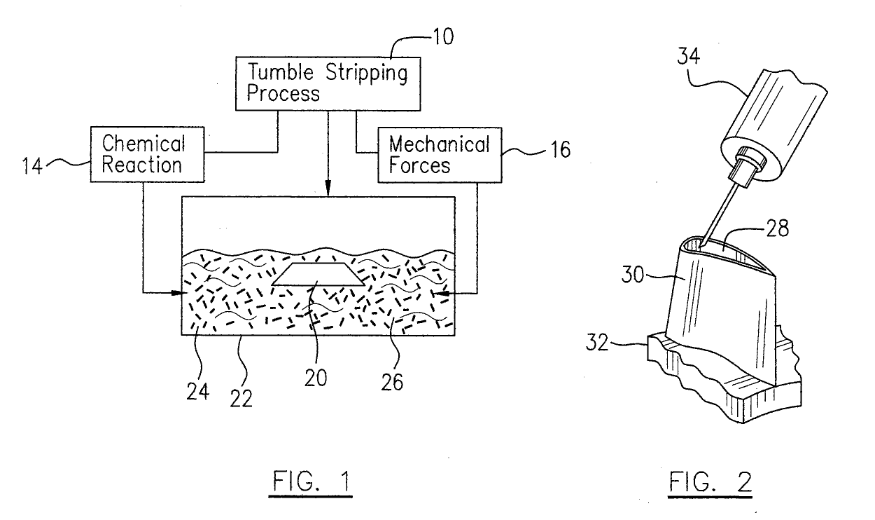

FIG. 1 illustrates an embodiment of the present invention in which a gas turbine component such as a turbine rotor blade or a vane ring (generally referred to as a gas turbine airfoil component 20 hereinafter). The gas turbine airfoil component 20 is subjected to a tumble stripping process 10 prior to a repair operation, by being placed within a container 22 and being bathed in an acid solution 24 which is also contained within the container 22. A coating layer of the gas turbine airfoil component 20 is therefore in contact with the acid solution 24 and is subjected to a chemical reaction between the acid solution 24 and at least one metal element of the coating layer of the gas turbine airfoil component 20. Meanwhile the coating layer of the gas turbine airfoil component 20 is also subjected to mechanical forces of a plurality of hard media elements 26 which are accommodated within the container 22 and are in a tumbling motion, thereby resulting in a rubbing action thereof on the coated surface of the gas turbine airfoil component 20. Therefore, the coating layer of the gas turbine airfoil component 20 is removed by both mechanical and chemical reactions in the tumble stripping process 10.

Tumbling, or tumble polishing, is a technique well known for smoothing and polishing a hard substance. Within the field of metal work, this is known as “barrelling” or “barrel polishing” and is subtly different but uses under the same principles. For example, in a tumbling process of rocks as a lapidary technique, a rubber barrel is loaded with consignment of rocks, all of similar or the same hardness, some abrasive grit, and a lubricant. Silicon carbide grit is commonly used, and water is a universal lubricant. The barrel is then placed upon slowly rotating rails so that it rotates. This causes the rocks within the barrel to slide past each other, with the abrasive grit between them. The result of this depends on the coarseness of the abrasive, and the duration of the tumble. The tumble polishing process usually takes a very long period of time to achieve the desirable results. The conventional tumbling technique for polishing only involves mechanical forces applied to the surfaces of the object and there is no chemical reaction involved.

It should be noted that the terms “tumbling motion” and “tumble” used throughout the specification and claims of this patent application have a broad meaning as a technical term, including a number of types of motion which results in the hard media elements 26 sliding on the surfaces of the gas turbine airfoil components 20, thereby creating a rubbing action to same.

In accordance with one aspect of the present invention, the acid solution 24 is selected to dissolve at least one metal element, different from a base metal of the gas turbine airfoil component 20. The acid solution 24 does not therefore substantially dissolve the base metal. For example, a gas turbine airfoil component which is made of a nickel super alloy as its base metal, is covered by a coating layer including nickel 60-70% by weight, aluminium 22-28% by weight, cobalt 4-8% by weight and chrome 2-4% by weight. The coating layer may further comprise Titanium, Tantalium, Wolfram, Molybdenum, Rhodium and/or Zirconium. An acid solution may be selected from a dilute mixture of a nitric acid and ammonium bifluoride, for example. The acid solution may comprise a nitric acid of 20-30% by volume mixed with ammonium bifluoride of 40-60 grams/litre. The selected acid solution is adapted to dissolve aluminium but to not substantially dissolve nickel. Therefore, the coating layer is substantially attacked by the chemical reaction between the acid and the aluminium element in the coating layer but the base metal of the gas turbine airfoil component is not attacked by the acid.

The nickel super alloy as the base metal of the gas turbine airfoil component, is much harder than the smutted coating layer because the aluminium element of the coating layer is being dissolved by the acid solution. Therefore the mechanical forces resulting from the rubbing action between the surfaces of the gas turbine airfoil component and the hard media elements in the tumbling motion are enabled to remove the coating layer smut from the surfaces of the gas turbine airfoil component, but do not damage the much harder base metal of the component.

In accordance with another aspect of the present invention, hard media elements, for example, may be made of a hard smooth-surfaced porcelain material containing very little Aluminium 203 to prevent the hard media elements from being attacked by the acid solution. Hard and rough ceramics composed of SiOx can also be used as an alternative.

The hard media elements may be formed in any shape, such as a wedge-like configuration, cylindrical configuration, cubic blocks, etc. The individual hard media elements are appropriately dimensioned, for example, to provide a maximum surface measurement less than or equal to 0.375 inches on any side thereof.

In such a tumble stripping process of the present invention, the coating layer may be removed at approximately 0.001 inches per hour while the nickel and cobalt super alloys exhibit very little base metal attack.

In FIG. 1, the container 22 and the equipment (not shown) used in the tumble stripping process 10 of the present invention may be similar to those used in the conventional tumbling processes, or may be otherwise specially designed for the tumble stripping process 10 of the present invention. However, this is not part of the subject matter of this invention and therefore will not be further described herein. Nevertheless, it should be noted that the container 22 or an internal liner of the container (not shown) may be made from a material which tolerates both the acid solution 24 contained therein and the mechanical rubbing forces of the hard media elements 26 in a tumbling motion. The container 22 is dimensioned to hold the acid solution in an amount of between 60-80 gallons, for example. The tumbling motion of the hard media elements 26 within the container 22 may result from a slow rotation of the container 22 (which is sealed during operation) about for example a horizontal axis thereof, or may result from a vibration of the container (which may remain open during operation), depending on the operating equipment associated therewith.

In FIG. 2, according to a further aspect of the present invention, internal cavities such as a hollow space 28 defined in a hollow airfoil 30 of a gas turbine vane ring 32 are protected in a tumble stripping process of the present invention. The inner surfaces in such a hollow space 28 are not covered by the coating layer and thus should not be exposed to the effects of the acid solution used in the tumble stripping process of the present invention. In addition, some of the hard media elements may become broken into fragments during a tumble stripping process and the hard media fragments may become imbedded in the unprotected hollow space 28, which is also not desireable. Therefore, a resin epoxy-like material such as Speedmask®, manufactured by Dymax, which is UV light curable and chemically inert in acids, can be applied in the hollow space 28 to thereby block the opening, for example by using a standard syringe-dispensing system 34. Ultraviolet light is then used to cure the epoxy-like material to a hardened condition, thereby becoming impervious to grit blasting part of the pre-treatment, and to the hard media elements during a tumbling motion and to chemical attack of the acid solution. This protecting step is conducted prior to the tumble stripping process 10 illustrated in FIG. 1. After the coating layer has been removed in the tumble stripping process, the cured Speedmask® resin material is pulverized by heating the component, such as the gas turbine vane ring 32 to a burnout temperature of 1000-1200 degrees Fahrenheit for about 15 minutes. The Speedmask® resin material then decomposes into a dust-like substance which can be removed by a grit blasting process, which is conventional and well known in the art.

In another embodiment of the present invention, prior to conducting the tumble stripping process 10 shown in FIG. 1, a first conventional grit blasting process may be conducted to the gas turbine airfoil component 20 to remove a preliminary amount of the coating layer on the gas turbine airfoil component 20, for example up to 30% of metal (coating layer) thereof. After the first conventional grit blasting process, the gas turbine airfoil component 20 is then subjected to the tumble stripping process 10 as shown in FIG. 1, to remove a substantial amount of the coating layer, for example up to 60% of metal (coating layer). Therefore, a significant amount of the coating layer, up to 90% of metal is removed after the first grit blasting process and the tumble stripping process 10. Finally, a second conventional grit blasting process can be conducted to the gas turbine airfoil component 20 to complete the removal of the coating layer from the gas turbine airfoil component 20. The second conventional grit blasting process will remove the remaining part of the coating layer, from 10% of metal (coating layer) or more, depending on the effectiveness of the tumble stripping process 10. Therefore, the second conventional grit blasting process can be adjusted accordingly.

Heat tinting at elevated temperatures is the method of choice to check for residue coating elements on the surfaces of gas turbine airfoil components after a coating stripping process is conducted. A purple-blue colour on the surfaces of the gas turbine airfoil component indicates that the coating layer has been substantially removed. A gold colour indicates that the coating metal materials in both diffusion zone and growth zone remain on the gas turbine airfoil component. A brown colouration indicates that coating materials remain only in the diffusion zone. Furthermore, after a coating layer stripping process the gas turbine airfoil components may be inspected by a step of Florescent Penetrant Inspection (FPI) in order to protect the gas turbine airfoil components from over-stripping. This step includes spraying an indicating penetrant onto the surfaces of gas turbine airfoil components which have been treated in a coating layer stripping process. The sprayed gas turbine airfoil components are dried and then inspected under “black” ultraviolet light to indicate porosity. A heavy indication of bright spots on the surfaces of the component can indicate pitting or intergranular attack caused by an overzealous stripping process.

The tumble stripping process of the present invention for removing a coating layer from a gas turbine airfoil component advantageously minimizes trailing edge dimensional loss of the airfoil component. The tumble stripping process of the present invention advantageously provides more consistent airflow measurements because coating layers of gas turbine airfoil components are removed in a slow continuous manner by both mechanical and chemical action. Furthermore, in contrast to conventional electrolytic stripping processes, less etch acid solutions are used in the tumble stripping process of the present invention and acid reclaim is easier and less costly to handle when the tumble stripping process of the present invention is used as an alternative to conventional electrolytic stripping processes.

The above description is meant to be exemplary only, and one skilled in the art will recognize that changes may be made to the embodiments described without departure from the scope of the invention disclosed. For example, although gas turbine airfoil components referred to as turbine blades and vane rings are used as an example to describe the tumble stripping process of the present invention, other gas turbine components are also applicable for this invention if it is desirable. The particular acid solution in the described embodiments is used as an example but does not limit this invention. Any other mixture of acid solution in accordance with the principle taught in this invention may be used, depending on the particular objects to be processed. Still other modifications which fall within the scope of the present invention will be apparent to those skilled in the art, in light of a review of this disclosure, and such modifications are intended to fall within the appended claims.

1. A method of removing a coating layer from a gas turbine airfoil component, comprising a step of applying both mechanical and chemical actions in a tumble stripping process to the coating layer of the gas turbine airfoil component, wherein the gas turbine airfoil component is bathed in an acid solution while being rubbed by a plurality of hard media elements in a tumbling motion.

2. The method as defined in claim 1 wherein the acid solution is adapted to dissolve aluminium but not substantially to dissolve nickel.

3. The method as defined in claim 2 wherein the acid solution comprises a dilute mixture of a nitric acid and ammonium bifluoride.

4. The method as defined in claim 2 wherein the acid solution comprises a nitric acid of 20-30% by volume mixed with ammonium bifluoride of 40-60 grams/litre.

5. The method as defined in claim 1 wherein the hard media elements are made of ceramics.

6. The method as defined in claim 1 wherein the hard media elements comprise porcelain stones.

7. The method as defined in claim 1 wherein the hard media elements are individually configured in a cylindrical shape.

8. The method as defined in claim 1 wherein the hard media elements are individually configured in a wedge-shape.

9. The method as defined in claim 1 wherein the hard media elements are individually dimensioned to provide a maximum surface measurement not larger than 0.375 inches on any side of the respective hard media elements.

10. The method as defined in claim 1 comprising a step of protecting a cavity of the gas turbine airfoil component which is not covered by the coating layer, from contact with the acid solution and the hard media elements during the tumble stripping process.

11. The method as defined in claim 10 wherein the protecting step is practised by applying a resin material to block the cavity prior to the tumble stripping process.

12. The method as defined in claim 11 wherein the protecting step is further practised by applying ultraviolet lights to the resin material to cure the same, prior to the tumble stripping process.

13. The method as defined in claim 12 wherein the protecting step is further practiced by heating the cured resin material until the same is burned out.

14. The method as defined in claim 13 wherein a grit blasting process is conducted to remove a dusk-like substance resulting from the burning process of the cured resin material.

15. The method as defined in claim 1 comprising a step of conducting a first grit blasting process to the gas turbine airfoil component prior to conducting the tumble stripping process.

16. The method as defined in claim 15 comprising a step of conducting a second grit blasting process to the gas turbine airfoil component after conducting the tumble stripping process.

17. The method as defined in claim 16 wherein the first grit blasting process is completed and the tumble stripping process begins when up to 30% of the coating layer material is removed.

18. The method as defined in claim 16 wherein the tumble stripping process is completed and the second grit blasting process begins when up to 90% of the coating layer material is removed.

19. A method of removing a coating layer from a gas turbine component, the coating layer including at least one metal element different from a base metal of the component, the method comprising a step of applying both mechanical and chemical actions in a tumble stripping process to the coating layer of the component, wherein the gas turbine component is bathed in an acid solution while being rubbed by a plurality of hard media elements in a tumbling motion.

20. The method as defined in claim 19 wherein the acid solution is adapted to dissolve the at least one metal element in the coating layer but not substantially to dissolve the base metal of the component.
